(19) United States
(12) Patent Application Publication
(10) Pub. No.: US 2010/0322067 A1
(43) Pub. Date: Dec. 23, 2010

(54) METHOD AND APPARATUS TO FACILIATE REESTABLISHING COMMUNICATIONS IN A WIRELESS NETWORK

(75) Inventor: Nathan Edward Tenny, Poway, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/818,067

(22) Filed: Jun. 17, 2010

Related U.S. Application Data
(60) Provisional application No. 61/218,776, filed on Jun. 19, 2009.

(51) Int. Cl. H04W 72/04; G06F 11/00; H04W 36/00

(52) U.S. Cl. 370/216; 370/329; 370/331

(57) ABSTRACT

Methods, apparatuses, and computer program products are disclosed that facilitate reestablishing a communication between a wireless terminal and a network. These embodiments include transmitting a reestablishment request from a wireless terminal to a network node via a source carrier. A reestablishment command is then received by the wireless terminal, which includes configuration data associated with at least one target carrier. A radio resource connection between the wireless terminal and the network is then reestablished via the at least one target carrier.

### CROSS-REFERENCE TO RELATED APPLICATIONS

This application claims the benefit of U.S. Provisional Patent Application Ser. No. 61/218,776 entitled “MULTICARRIER REESTABLISHMENT,” which was filed Jun. 19, 2009. The aforementioned application is herein incorporated by reference in its entirety.

### BACKGROUND

I. Field

The following description relates generally to wireless communications, and more particularly to methods and apparatuses that facilitate reestablishing communications in a wireless network.

II. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

With respect to reestablishing a radio connection, it is noted that current radio resource control (RRC) connection reestablishment procedures in LTE do not provide an adequate mechanism for reestablishing a radio connection in a multicarrier environment. Accordingly, methods and apparatuses that facilitate an efficient radio connection reestablishment within a multicarrier environment are desirable.

The above-described deficiencies of current wireless communication systems are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with reestablishing communications in a wireless system. In one aspect, methods and computer program products are disclosed that facilitate reestablishing a communication with a network. These embodiments include transmitting a reestablishment request via a source carrier, and receiving a reestablishment command. Here, the reestablishment command includes configuration data associated with at least one target carrier. These embodiments then further include establishing a radio resource connection via the at least one target carrier by employing a signaling format that facilitates a potential configuration associated with a plurality of target carriers.

In another aspect, an apparatus configured to facilitate reestablishing a communication with a network is disclosed. Within such embodiment, the apparatus includes a processor configured to execute computer executable components stored in memory. The computer executable components include a transmitting component, a receiving component, and a connecting component. The transmitting component is configured to transmit a reestablishment request via a source carrier, whereas the receiving component is configured to receive a reestablishment command. For this embodiment, the reestablishment command includes configuration data associated with at least one target carrier. The connecting component is then configured to establish a radio resource connection via the at least one target carrier by employing a signaling format that facilitates a potential configuration associated with a plurality of target carriers.

In a further aspect, another apparatus is disclosed. Within such embodiment, the apparatus includes means for transmitting, means for receiving, and means for establishing. For this embodiment, the means for transmitting is configured to transmit a reestablishment request via a source carrier, whereas the means for receiving is configured to receive a reestablishment command. For this embodiment, the reestablishment command includes configuration data associated with at least one target carrier. The means for establishing is then configured to establish a radio resource connection via the at least one target carrier by employing a signaling format that facilitates a potential configuration associated with a plurality of target carriers.

In another aspect, methods and computer program products are disclosed for reestablishing a communication with a wireless terminal These embodiments include receiving a reestablishment request via a source carrier, and selecting a target carrier subset from a set of candidate carriers. A reestablishment command is then generated, wherein the reestablishment command includes configuration data associated with the target carrier subset. This embodiment further include, transmitting the reestablishment command, wherein the reestablishment command is configured to facilitate establishing a radio resource connection via the target carrier subset by employing a signaling format that facilitates a potential configuration associated with a plurality of target carriers.

An apparatus for reestablishing a communication with a wireless terminal is also disclosed. Within such embodiment, the apparatus includes a processor configured to execute computer executable components stored in memory. The computer executable components include a receiving component, a selection component, a generation component, and a transmitting component. The receiving component is configured to receive a reestablishment request via a source carrier, whereas the selection component is configured to select a target carrier subset from a set of candidate carriers. The generation component is then configured to generate a reestablishment command, wherein the reestablishment command includes configuration data associated with the target carrier subset. Furthermore, the transmitting component is configured to transmit the reestablishment command, wherein the reestablishment command is configured to facilitate establishing a radio resource connection via the target carrier subset by employing a signaling format that facilitates a potential configuration associated with a plurality of target carriers.

In a further aspect, another apparatus is disclosed. Within such embodiment, the apparatus includes means for receiving, means for selecting, means for generating, and means for transmitting. For this embodiment, the means for receiving is configured to receive a reestablishment request via a source carrier, whereas the means for selecting is configured to select a target carrier subset from a set of candidate carriers. The means for generating is then configured to generate a reestablishment command, wherein the reestablishment command includes configuration data associated with the target carrier subset. Furthermore, the means for transmitting is configured to transmit the reestablishment command, wherein the reestablishment command is configured to facilitate establishing a radio resource connection via the target carrier subset by employing a signaling format that facilitates a potential configuration associated with a plurality of target carriers.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an exemplary wireless network environment that can be employed in conjunction with the various systems and methods described herein.

FIG. 3 illustrates an exemplary system that facilitates reestablishing a communication in accordance with an aspect of the subject specification.

FIG. 4 illustrates an exemplary method of reestablishment to a single carrier in accordance with an aspect of the subject specification.

FIG. 5 illustrates an exemplary method of reestablishment to multiple carriers in accordance with an aspect of the subject specification.

FIG. 6 illustrates an exemplary method of reestablishment directly into a multicarrier configuration in accordance with an aspect of the subject specification.

FIG. 7 illustrates a block diagram of an exemplary wireless terminal that facilitates reestablishing a communication with a network in accordance with an aspect of the subject specification.

FIG. 8 is an illustration of an exemplary coupling of electrical components that effectuate reestablishing a communication with a network.

FIG. 9 illustrates a block diagram of an exemplary base station that facilitates reestablishing a communication with a wireless terminal in accordance with an aspect of the subject specification.

FIG. 10 is an illustration of an exemplary coupling of electrical components that effectuate reestablishing a communication with a wireless terminal

FIG. 11 is an illustration of an exemplary communication system implemented in accordance with various aspects including multiple cells.

FIG. 12 is an illustration of an exemplary base station in accordance with various aspects described herein.

FIG. 13 is an illustration of an exemplary wireless terminal implemented in accordance with various aspects described herein.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The subject specification is directed towards reestablishing a radio connection for a UE in a multicarrier system. Embodiments are disclosed for reestablishing such connection to a single carrier configuration, as well as directly into a multicarrier configuration.

The techniques described herein can be used for various wireless communication systems such as code division multiple access (CDMA), time division multiple access (TDMA), frequency division multiple access (FDMA), orthogonal frequency division multiple access (OFDMA), single carrier-frequency division multiple access (SC-FDMA), High Speed Packet Access (HSPA), and other systems. The terms “system” and “network” are often used interchangeably. A CDMA system can implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink.

Single carrier frequency division multiple access (SC-FDMA) utilizes single carrier modulation and frequency domain equalization. SC-FDMA has similar performance and essentially the same overall complexity as those of an OFDMA system. A SC-FDMA signal has lower peak-to-average power ratio (PAPR) because of its inherent single carrier structure. SC-FDMA can be used, for instance, in uplink communications where lower PAPR greatly benefits access terminals in terms of transmit power efficiency. Accordingly, SC-FDMA can be implemented as an uplink multiple access scheme in 3GPP Long Term Evolution (LTE) or Evolved UTRA.

High speed packet access (HSPA) can include high speed downlink packet access (HSDPA) technology and high speed uplink packet access (HSUPA) or enhanced uplink (EUL) technology and can also include HSPA+ technology. HSDPA, HSUPA and HSPA+ are part of the Third Generation Partnership Project (3GPP) specifications Release 5, Release 6, and Release 7, respectively.

High speed downlink packet access (HSDPA) optimizes data transmission from the network to the user equipment (UE). As used herein, transmission from the network to the user equipment UE can be referred to as the “downlink” (DL). Transmission methods can allow data rates of several Mbits/s. High speed downlink packet access (HSDPA) can increase the capacity of mobile radio networks. High speed uplink packet access (HSUPA) can optimize data transmission from the terminal to the network. As used herein, transmissions from the terminal to the network can be referred to as the “uplink” (UL). Uplink data transmission methods can allow data rates of several Mbit/s. HSPA+ provides even further improvements both in the uplink and downlink as specified in Release 7 of the 3GPP specification. High speed packet access (HSPA) methods typically allow for faster interactions between the downlink and the uplink in data services transmitting large volumes of data, for instance Voice over IP (VoIP), videoconferencing and mobile office applications

Fast data transmission protocols such as hybrid automatic repeat request, (HARQ) can be used on the uplink and downlink. Such protocols, such as hybrid automatic repeat request (HARQ), allow a recipient to automatically request retransmission of a packet that might have been received in error.

Various embodiments are described herein in connection with an access terminal An access terminal can also be called a system, subscriber unit, subscriber station, mobile station, mobile, remote station, remote terminal, mobile device, user terminal, terminal, wireless communication device, user agent, user device, or user equipment (UE). An access terminal can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with access terminal(s) and can also be referred to as an access point, Node B, Evolved Node B (eNodeB), access point base station, or some other terminology.

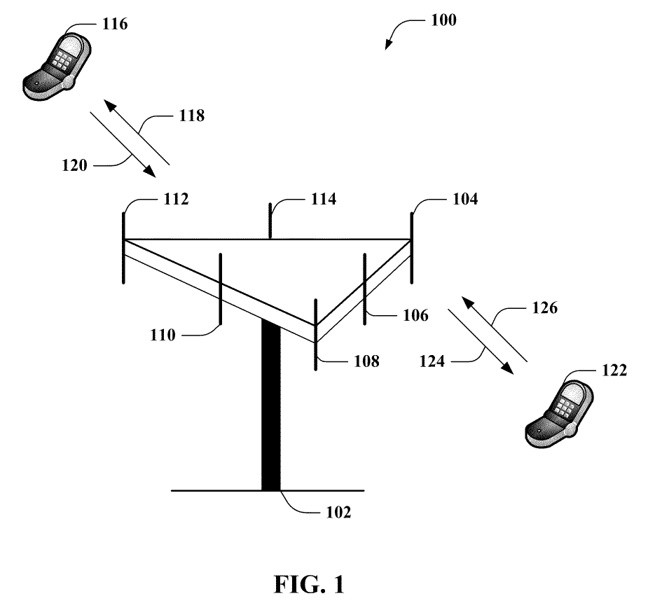

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more access terminals such as access terminal 116 and access terminal 122; however, it is to be appreciated that base station 102 can communicate with substantially any number of access terminals similar to access terminals 116 and 122. Access terminals 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, access terminal 116 is in communication with antennas 112 and 114, where antennas 112 and 114 transmit information to access terminal 116 over a forward link 118 and receive information from access terminal 116 over a reverse link 120. Moreover, access terminal 122 is in communication with antennas 104 and 106, where antennas 104 and 106 transmit information to access terminal 122 over a forward link 124 and receive information from access terminal 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to access terminals in a sector of the areas covered by base station 102. In communication over forward links 118 and 124, the transmitting antennas of base station 102 can utilize beamforming to improve signal-to-noise ratio of forward links 118 and 124 for access terminals 116 and 122. Also, while base station 102 utilizes beamforming to transmit to access terminals 116 and 122 scattered randomly through an associated coverage, access terminals in neighboring cells can be subject to less interference as compared to a base station transmitting through a single antenna to all its access terminals.

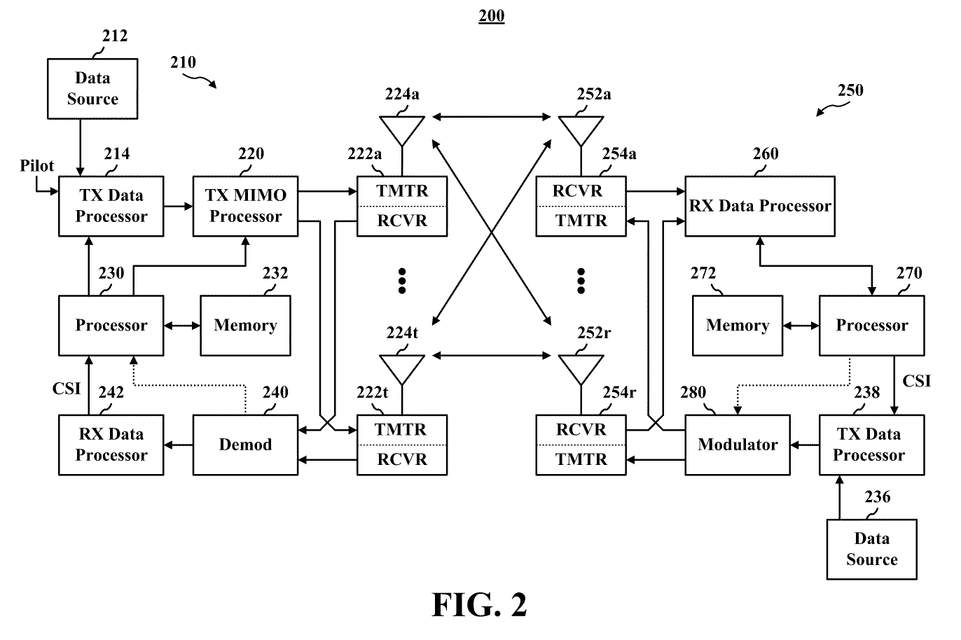

FIG. 2 shows an example wireless communication system 200. The wireless communication system 200 depicts one base station 210 and one access terminal 250 for sake of brevity. However, it is to be appreciated that system 200 can include more than one base station and/or more than one access terminal, wherein additional base stations and/or access terminals can be substantially similar or different from example base station 210 and access terminal 250 described below. In addition, it is to be appreciated that base station 210 and/or access terminal 250 can employ the systems and/or methods described herein to facilitate wireless communication there between.

At base station 210, traffic data for a number of data streams is provided from a data source 212 to a transmit (TX) data processor 214. According to an example, each data stream can be transmitted over a respective antenna. TX data processor 214 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at access terminal 250 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides N_{T} modulation symbol streams to N_{T} transmitters (TMTR) 222a through 222t. In various embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 222a through 222t are transmitted from N_{T} antennas 224a through 224t, respectively.

At access terminal 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective signal, digitizes the conditioned signal to provide samples, and further processes the samples to provide a corresponding “received” symbol stream.

An RX data processor 260 can receive and process the N_{R} received symbol streams from N_{R} receivers 254 based on a particular receiver processing technique to provide N_{T} “detected” symbol streams. RX data processor 260 can demodulate, deinterleave, and decode each detected symbol stream to recover the traffic data for the data stream. The processing by RX data processor 260 is complementary to that performed by TX MIMO processor 220 and TX data processor 214 at base station 210.

A processor 270 can periodically determine which available technology to utilize as discussed above. Further, processor 270 can formulate a reverse link message comprising a matrix index portion and a rank value portion.

The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from access terminal 250 are received by antennas 224, conditioned by receivers 222, demodulated by a demodulator 240, and processed by a RX data processor 242 to extract the reverse link message transmitted by access terminal 250. Further, processor 230 can process the extracted message to determine which precoding matrix to use for determining the beamforming weights.

Processors 230 and 270 can direct (e.g., control, coordinate, manage, etc.) operation at base station 210 and access terminal 250, respectively. Respective processors 230 and 270 can be associated with memory 232 and 272 that store program codes and data. Processors 230 and 270 can also perform computations to derive frequency and impulse response estimates for the uplink and downlink, respectively.

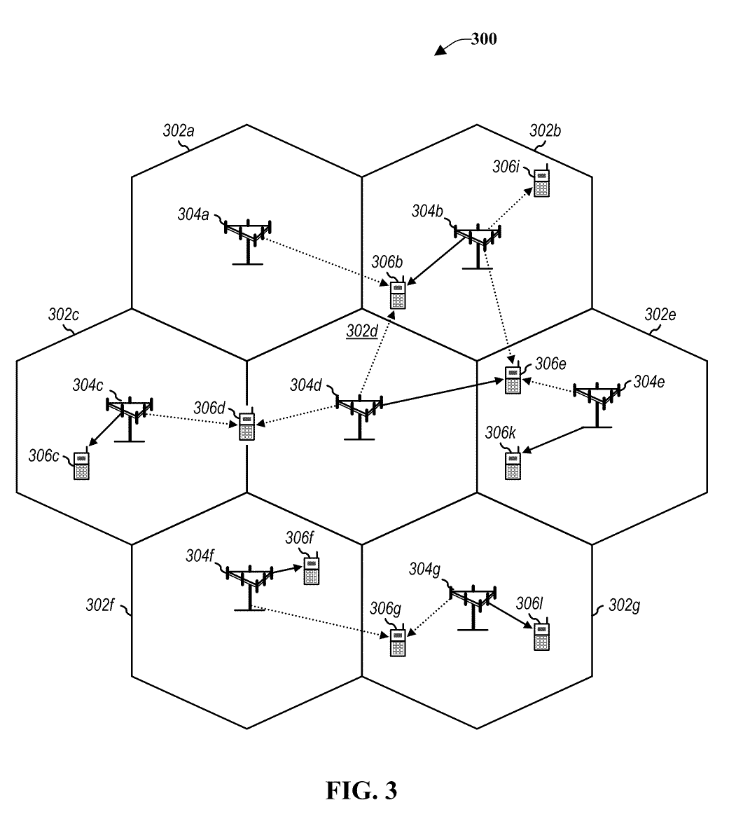

FIG. 3 illustrates an example wireless communication system 300 configured to support a number of users, in which various disclosed embodiments and aspects may be implemented. As shown in FIG. 3, by way of example, system 300 provides communication for multiple cells 302, such as, for example, macro cells 302a-302g, with each cell being serviced by a corresponding access point (AP) 304 (such as APs 304a-304g). Each cell may be further divided into one or more sectors (e.g. to serve one or more frequencies). Various access terminals (ATs) 306, including ATs 306a-306k, also known interchangeably as user equipment (UE) or mobile stations, are dispersed throughout the system. Each AT 306 may communicate with one or more APs 304 on a forward link (FL) and/or a reverse link (RL) at a given moment, depending upon whether the AT is active and whether it is in soft handoff, for example. The wireless communication system 300 may provide service over a large geographic region, for example, macro cells 302a-302g may cover a few blocks in a neighborhood.

It is to be appreciated that, in an LTE network, RRC connection reestablishment is typically used for two general purposes: Handover and recovery from a failure (e.g., radio link failure, RLC failure, etc.). In cases other than handover, it is reasonably likely that the UE actually performs reestablishment in the same cell that was serving it before the failure took place. In such a case, the term “reestablishment” is intended to infer that the serving AP 304 (e.g., eNodeB) can associate the AT 306 with the resources and context that were already reserved for it, without the need to perform new resource allocations and internal configuration activities.

The design of LTE specifies that the ATs 306 typically cannot perform reestablishment directly into their complete configurations. Specifically, after the reestablishment procedure is complete, the ATs 306 each have a single signaling radio bearer established for connection with the network. The establishment of other bearers and the flow of user-plane data cannot occur until an additional reconfiguration procedure has taken place. In the case of a multicarrier configuration, existing reestablishment procedures would provide a facility only for configuring a single signaling radio bearer on a single carrier, requiring a subsequent procedure to configure additional carriers as well as to establish additional bearers. Aspects disclosed herein provide several alternative reestablishment procedure embodiments. A first embodiment, for example, provides the ATs 306 with only a single-carrier configuration at reestablishment, while a second embodiment provides the ATs 306 directly with a multiple-carrier configuration. It is to be appreciated that the foregoing represents but a few examples, and that those skilled in the art will be able to readily identify additional equivalent examples. For example, while the innovation is described in terms of an LTE-A network, it is to be appreciated that it can apply to any of various multicarrier networks. Moreover, although the disclosed aspects could in principle be applied in handover cases as well, they are directed primarily to the case of reestablishment in a cell that was previously serving the UE (i.e., to cases such as radio link failure recovery).

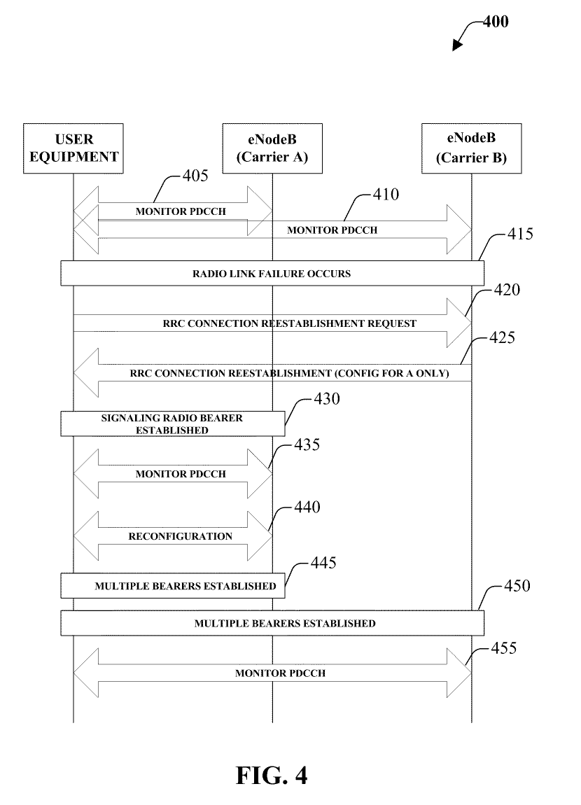

Referring next to FIG. 4, an exemplary method of reestablishment to a single carrier is illustrated in accordance with an aspect of the subject innovation. As illustrated, process 400 includes a series of acts that may be performed by various components of a network according to an aspect of the subject specification. Process 400 may be implemented by employing at least one processor to execute computer executable instructions stored on a computer readable storage medium to implement the series of acts. In another embodiment, a computer-readable storage medium comprising code for causing at least one computer to implement the acts of process 400 is contemplated.

As illustrated, process 400 begins with a monitoring of the Physical Downlink Control Channel (PDCCH) on carriers A and B, at acts 405 and 410, respectively. At act 415, the occurrence of a radio link failure (RLF) is detected, which triggers the transmission of an RRC connection reestablishment request at act 420. An RRC connection reestablishment is then performed at act 425, followed by the establishment of a signaling radio bearer on carrier A at act 430. After establishing the signaling radio bearer on carrier A, the PDCCH is again monitored over carrier A at act 435, followed by a reconfiguration of carrier A at act 440. Multiple bearers are then established over carrier A at act 445, as well as over carrier B at act 450. Process 400 then concludes with the monitoring of PDCCH over carrier B.

As shown in the process 400, a UE concludes a reestablishment procedure with a configuration on only one carrier (which may or may not be the same carrier on which it performed random access to request reestablishment). Here, it should be noted that the reestablishment procedure of process 400 actually takes place with carrier B, but establishes a configuration on carrier A. In an aspect, the choice of “target” carrier for the reestablishment would typically be a matter for network implementation to decide. Since in a typical multicarrier configuration all carriers are operated by a single eNode B, it is contemplated that such “cross-carrier” resource assignments are achievable. In general, the reestablishment procedure could direct the UE to any carrier.

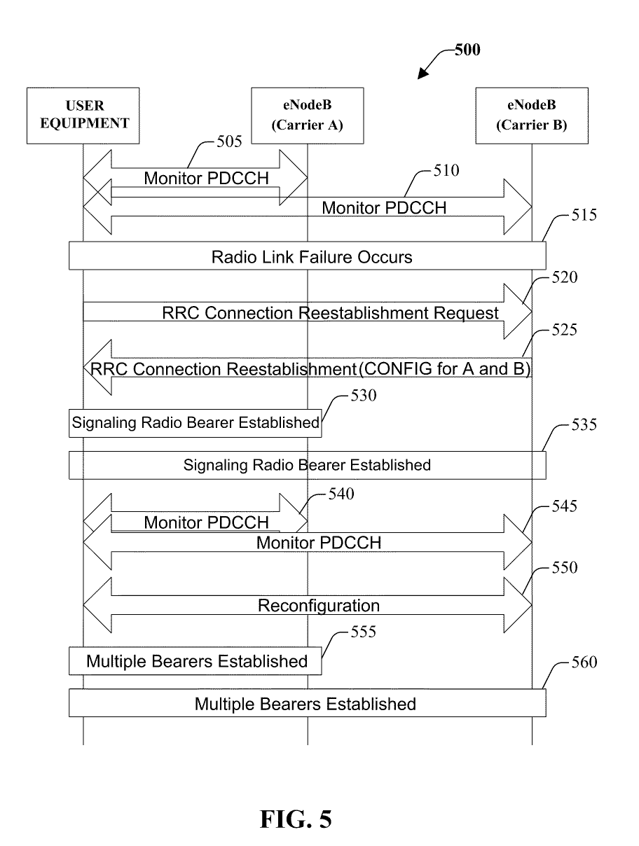

Referring next to FIG. 5, an exemplary method of reestablishment to multiple carriers is illustrated in accordance with an aspect of the subject specification. Here, similar to process 400, process 500 includes a series of acts that may be performed by various components of a network according to an aspect of the subject specification. Process 500 may also be implemented by employing at least one processor to execute computer executable instructions stored on a computer readable storage medium to implement the series of acts. In another embodiment, a computer-readable storage medium comprising code which causes at least one computer to implement the acts of process 500 is contemplated.

In process 500, a UE is brought directly to a multiple-carrier configuration based on the contents of the reestablishment command from the network. Moreover, as illustrated, the connection reestablishment procedure brings the UE to multiple carriers, but actually establishes only the basic signaling radio bearer (SRB1) for each carrier. At this point, the serving eNodeB can send a reconfiguration to the UE through either carrier to establish additional bearers (e.g., for signaling or user-plane data).

Specifically, process 500 begins with a monitoring of the Physical Downlink Control Channel (PDCCH) on carriers A and B, at acts 505 and 510, respectively. At act 515, the occurrence of a radio link failure (RLF) is detected, which triggers the transmission of an RRC connection reestablishment request at act 520. An RRC connection reestablishment is then performed at act 525, followed by the establishment of a signaling radio bearer on carriers A and B at acts 530 and 535, respectively. After establishing the signaling radio bearers, the PDCCH is monitored over carriers A and B at acts 540 and 545, respectively, followed by a reconfiguration being performed at act 550. Multiple bearers are then established over carrier A at act 555, as well as over carrier B at act 560.

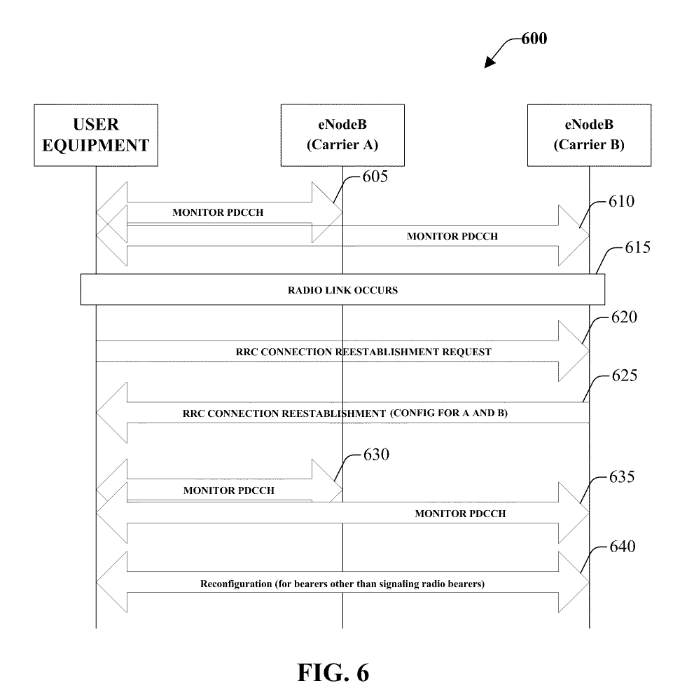

Referring next to FIG. 6, an exemplary method of reestablishment directly into a multicarrier configuration is illustrated in accordance with an aspect of the subject innovation. Here, similar to processes 400 and 500, process 600 includes a series of acts that may be performed by various components of a network according to an aspect of the subject specification. Process 600 may also be implemented by employing at least one processor to execute computer executable instructions stored on a computer readable storage medium to implement the series of acts. In another embodiment, a computer-readable storage medium comprising code which causes at least one computer to implement the acts of process 600 is contemplated.

Here, it is noted that a UE with radio resource assignments on several carriers needs to determine when to declare radio link failure, and what to do in case of a failure of some but not all of its radio links. It may be desirable that the UE declare radio link failure only when it has no radio links available through which it can communicate with the serving cell. If one of several radio links fails, the UE should report the fact to the serving cell, but remain connected without the need for an active recovery procedure. This can raise additional complications, in that the UE somehow has to make sure that its uplink grant to report the failure of one radio link is not sent on the same carrier that failed.

At least three options are disclosed herein. First, the eNB may be constrained to issue uplink grants on the (downlink portion of the) carrier where they were requested. Second, the UE may be provided with a mechanism for requesting uplink grants directed towards a particular carrier. Third, separate procedures may be defined by which the UE can indicate the failure of the radio link on one of its multiple carriers without the need for an uplink grant. In addition, there is a “do nothing” solution, in which the UE is given no mechanism for indicating the “partial failure” at all, and it is assumed that the eNode B will eventually determine independently that the UE has lost this radio link.

In the event that the UE experiences a failure of all carriers on which it is configured to receive the PDCCH, it may be desirable that it declare radio link failure. Maintaining the same handling as in LTE Release-8/9, the UE will then attempt reestablishment. Since the UE identifies itself in the reestablishment request, there are few if any logical obstacles to bringing the UE directly to a multicarrier configuration with the RRC Connection Reestablishment message. An exemplary flow for such an “instant multicarrier” reestablishment is provided in process 600.

While the UE is “brought back” on multiple carriers, it still needs to rely on a reconfiguration procedure to establish data bearers (as in Release-8/9, it is assumed that the reestablishment only provides the signaling radio bearer). However, this streamlined flow, as compared to reestablishing on a single carrier and then reconfiguring to add additional carriers to the UE's monitored set, can be helpful to the network implementation (e.g., from the perspective of maintaining bearer mappings).

Specifically, process 600 begins with a monitoring of the Physical Downlink Control Channel (PDCCH) on carriers A and B, at acts 605 and 610, respectively. At act 615, the occurrence of a radio link failure (RLF) is detected, which triggers the transmission of an RRC connection reestablishment request at act 620. An RRC connection reestablishment is then performed at act 625. The PDCCH is then monitored over carriers A and B at acts 640 and 645, respectively, followed by a reconfiguration being performed at act 650.

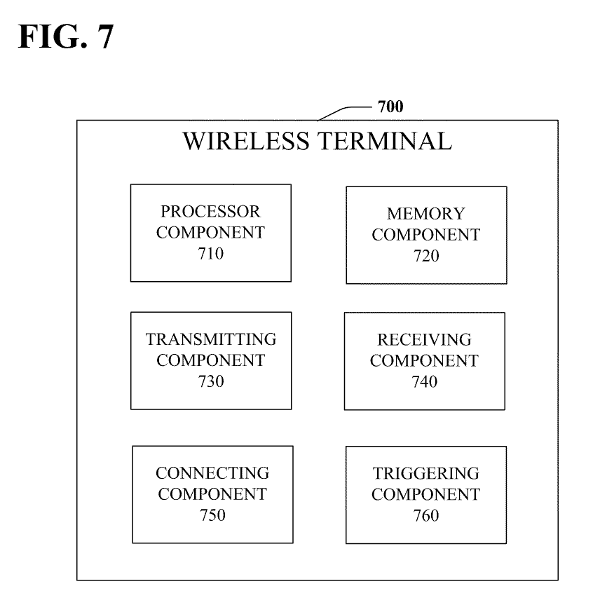

Referring next to FIG. 7, a block diagram of an exemplary wireless terminal that facilitates reestablishing a communication with a network according to an embodiment is provided. As shown, wireless terminal 700 may include processor component 710, memory component 720, transmitting component 730, receiving component 740, connecting component 750, and triggering component 760.

In one aspect, processor component 710 is configured to execute computer-readable instructions related to performing any of a plurality of functions. Processor component 710 can be a single processor or a plurality of processors dedicated to analyzing information to be communicated from wireless terminal 700 and/or generating information that can be utilized by memory component 720, transmitting component 730, receiving component 740, connecting component 750, and/or triggering component 760. Additionally or alternatively, processor component 710 may be configured to control one or more components of wireless terminal 700.

In another aspect, memory component 720 is coupled to processor component 710 and configured to store computer-readable instructions executed by processor component 710. Memory component 720 may also be configured to store any of a plurality of other types of data including generated by any of transmitting component 730, receiving component 740, connecting component 750, and/or triggering component 760. Memory component 720 can be configured in a number of different configurations, including as random access memory, battery-backed memory, hard disk, magnetic tape, etc. Various features can also be implemented upon memory component 720, such as compression and automatic back up (e.g., use of a Redundant Array of Independent Drives configuration).

In yet another aspect, wireless terminal 700 includes transmitting component 730 and receiving component 740, which are coupled to processor component 710 and configured to interface wireless terminal 700 with external entities. For instance, transmitting component 730 may be configured to transmit a reestablishment request via a source carrier, whereas receiving component 740 may be configured to receive a reestablishment command which includes configuration data associated with at least one target carrier. Here, it is contemplated that wireless terminal 700 may receive the reestablishment command from any of various network nodes. For instance, the reestablishment command may be received from a network node that previously provided a service to wireless terminal 700. Embodiments are also contemplated, wherein the reestablishment command is received from a node that previously allocated radio resources to wireless terminal 700 on the at least one target carrier.

As illustrated, wireless terminal 700 may also include connecting component 750. Within such embodiment, connecting component 750 is configured to establish a radio resource connection with a network via the at least one target carrier by employing a signaling format that facilitates a potential configuration associated with a plurality of target carriers. Here, it should be noted that at least one radio resource connection may include a signaling radio bearer. It should be further noted that various embodiments are contemplated for the at least one target carrier. For instance, the at least one target carrier can be a single carrier, as well as a plurality of carriers. Also, for some embodiments the at least one target carrier operates on the same frequency as the source carrier, whereas the at least one target carrier operates on a different frequency from the source carrier in other embodiments.

In an aspect, wireless terminal 700 further includes triggering component 760. Within such embodiment, triggering component 760 is configured to detect particular events which trigger a transmission of the reestablishment request. Here, it should be noted that triggering component 760 may be used for detecting any of a plurality of events. For instance, triggering component 760 may be configured to detect a radio link failure, wherein the reestablishment request is triggered by the radio link failure. In another aspect, triggering component 760 is configured to detect a failure in a transport layer of a wireless system, wherein the reestablishment request is triggered by the failure in the transport layer. In yet another aspect, triggering component 760 is configured to detect a handover command, wherein the reestablishment request is triggered by the handover command.

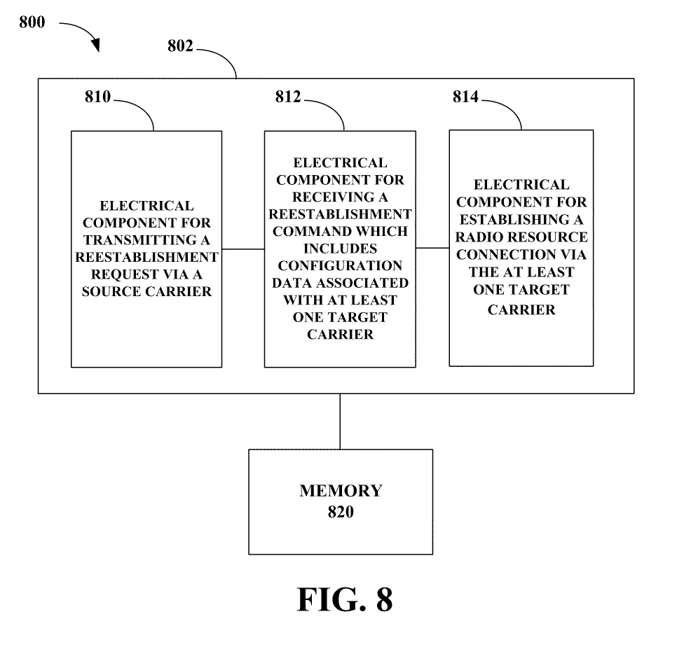

Turning to FIG. 8, illustrated is a system 800 that facilitates reestablishing a communication with a network according to an embodiment. System 800 and/or instructions for implementing system 800 can reside within user equipment (e.g., wireless terminal 700) or a computer-readable storage medium, for instance. As depicted, system 800 includes functional blocks that can represent functions implemented by a processor, software, or combination thereof (e.g., firmware). System 800 includes a logical grouping 802 of electrical components that can act in conjunction. As illustrated, logical grouping 802 can include an electrical component for transmitting a reestablishment request via a source carrier 810. Logical grouping 802 can also include an electrical component for receiving a reestablishment command which includes configuration data associated with at least one target carrier 812. Further, logical grouping 802 can include an electrical component for establishing a radio resource connection via the at least one target carrier 814. Additionally, system 800 can include a memory 820 that retains instructions for executing functions associated with electrical components 810, 812, and 814, wherein any of electrical components 810, 812, and 814 can exist either within or outside memory 820.

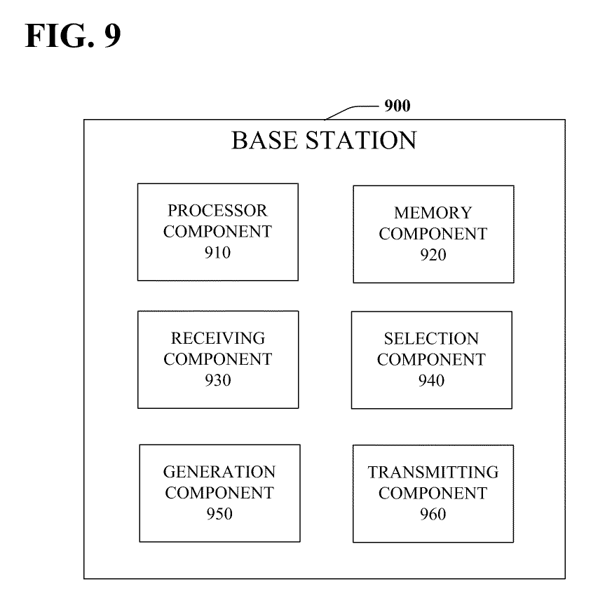

Referring next to FIG. 9, a block diagram illustrates an exemplary base station that facilitates reestablishing a communication with a wireless terminal in accordance with various aspects. As illustrated, base station 900 may include processor component 910, memory component 920, receiving component 930, selection component 940, generation component 950, and transmitting component 960.

Similar to processor component 710 in wireless terminal 700, processor component 910 is configured to execute computer-readable instructions related to performing any of a plurality of functions. Processor component 910 can be a single processor or a plurality of processors dedicated to analyzing information to be communicated from base station 900 and/or generating information that can be utilized by memory component 920, receiving component 930, selection component 940, generation component 950, and/or transmitting component 960. Additionally or alternatively, processor component 910 may be configured to control one or more components of base station 900.

In another aspect, memory component 920 is coupled to processor component 910 and configured to store computer-readable instructions executed by processor component 910. Memory component 920 may also be configured to store any of a plurality of other types of data including data generated by any of receiving component 930, selection component 940, generation component 950, and/or transmitting component 960. Here, it should be noted that memory component 1220 is analogous to memory component 720 in wireless terminal 700. Accordingly, it should be appreciated that any of the aforementioned features/configurations of memory component 720 are also applicable to memory component 920.

In yet another aspect, base station 900 includes receiving component 930 and transmitting component 960, which are coupled to processor component 910 and configured to interface base station 900 with external entities. For instance, receiving component 930 may be configured to receive a reestablishment request via a source carrier, whereas transmitting component 960 may be configured to transmit a reestablishment command to facilitate establishing a radio resource connection via at least one carrier of a target carrier subset by employing a signaling format that facilitates a potential configuration associated with a plurality of target carriers. Here, it is contemplated that the reestablishment command may be transmitted from any of various network nodes. For instance, transmitting component 960 may be configured to transmit the reestablishment command from a network node that previously provided a service to the wireless terminal Embodiments are also contemplated, wherein transmitting component 960 may be configured to transmit the reestablishment command from a node that previously allocated radio resources to the wireless terminal on at least one carrier included in the target carrier subset.

Base station 900 may also include selection component 940, which is configured to select the target carrier subset from a set of candidate carriers. Here, it should be noted that selection component 940 may be configured to select the target carrier subset in any of a plurality of ways. For instance, in a particular embodiment, selection component 940 is configured to monitor a usage of the set of candidate carriers, wherein the target carrier subset is selected based on the usage. It should be further noted that various embodiments are contemplated for the target carrier subset. For instance, the target carrier subset can be a single carrier, as well as a plurality of carriers. Also, for some single carrier embodiments, the single carrier operates on the same frequency as the source carrier, whereas the single carrier operates on a different frequency from the source carrier in other single carrier embodiments.

As illustrated, base station 900 may further include generation component 950. Within such embodiment, generation component 950 is configured to generate a reestablishment command which is transmitted to a wireless terminal via transmitting component 960. Here, it is contemplated that these reestablishment commands include configuration data associated with the target carrier subset selected by selection component 940.

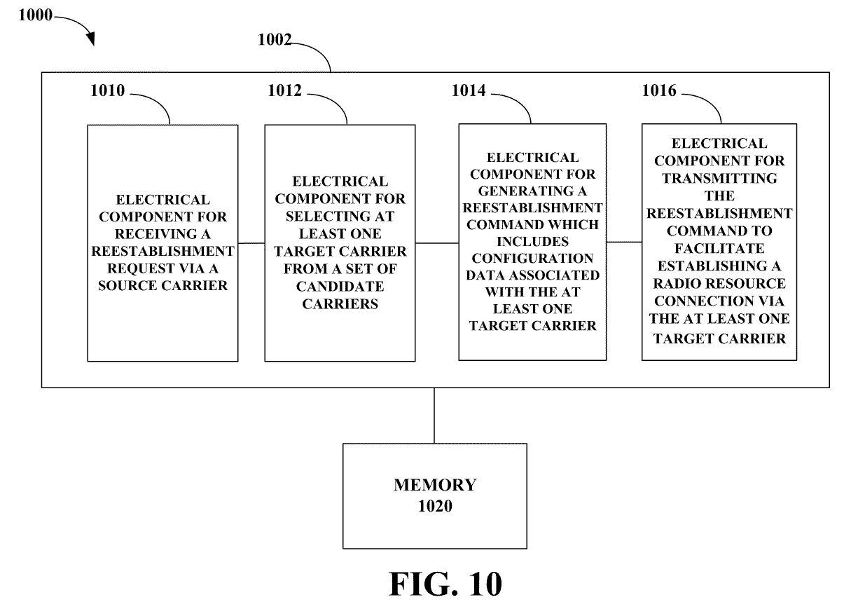

Referring next to FIG. 10, illustrated is a system 1000 that facilitates reestablishing a communication with a wireless terminal according to an embodiment. System 1000 and/or instructions for implementing system 1000 can reside within a network entity (e.g., base station 900) or a computer-readable storage medium, for instance, wherein system 1000 includes functional blocks that can represent functions implemented by a processor, software, or combination thereof (e.g., firmware). Moreover, system 1000 includes a logical grouping 1002 of electrical components that can act in conjunction similar to logical grouping 802 in system 800. As illustrated, logical grouping 1002 can include an electrical component for receiving a reestablishment request via a source carrier 1010, as well as an electrical component for selecting at least one target carrier from a set of candidate carriers 1012. Furthermore, logical grouping 1002 can include an electrical component for generating a reestablishment command which includes configuration data associated with the at least one target carrier 1014. Logical grouping 1002 can also include an electrical component for transmitting the reestablishment command to facilitate establishing a radio resource connection via the at least one target carrier 1016. Additionally, system 1000 can include a memory 1020 that retains instructions for executing functions associated with electrical components 1010, 1012, 1014, and 1016. While shown as being external to memory 1020, it is to be understood that electrical components 1010, 1012, 1014, and 1016 can exist within memory 1020.

### Exemplary Communication System

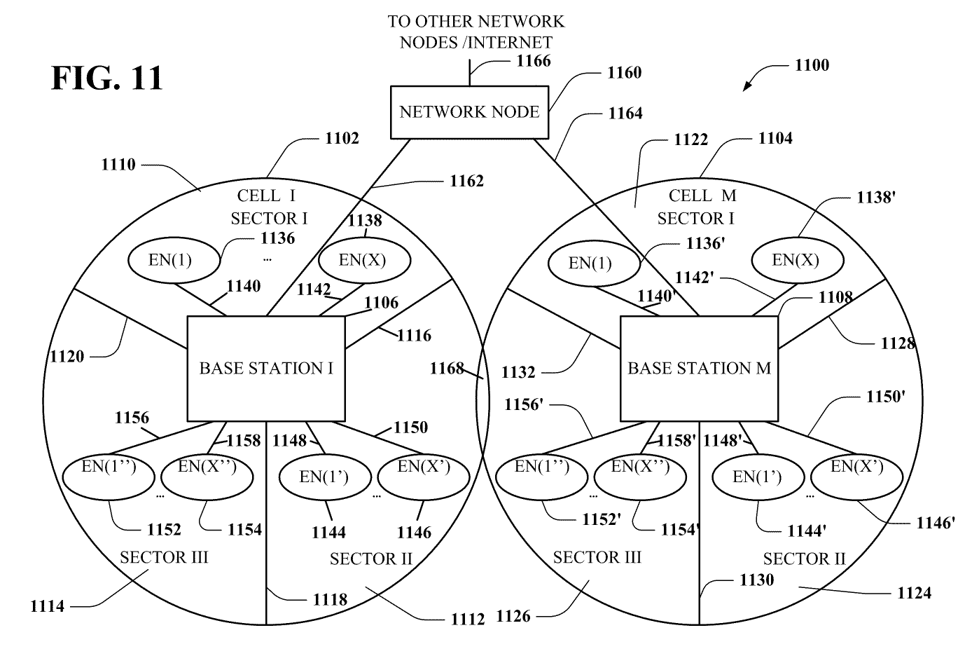

Referring next to FIG. 11, an exemplary communication system 1100 implemented in accordance with various aspects is provided including multiple cells: cell I 1102, cell M 1104. Here, it should be noted that neighboring cells 1102, 1104 overlap slightly, as indicated by cell boundary region 1168, thereby creating potential for signal interference between signals transmitted by base stations in neighboring cells. Each cell 1102, 1104 of system 1100 includes three sectors. Cells which have not been subdivided into multiple sectors (N=1), cells with two sectors (N=2) and cells with more than 3 sectors (N>3) are also possible in accordance with various aspects. Cell 1102 includes a first sector, sector I 1110, a second sector, sector II 1112, and a third sector, sector III 1114. Each sector 1110, 1112, and 1114 has two sector boundary regions; each boundary region is shared between two adjacent sectors.

Sector boundary regions provide potential for signal interference between signals transmitted by base stations in neighboring sectors. Line 1116 represents a sector boundary region between sector I 1110 and sector II 1112; line 1118 represents a sector boundary region between sector II 1112 and sector III 1114; line 1120 represents a sector boundary region between sector III 1114 and sector I 1110. Similarly, cell M 1104 includes a first sector, sector I 1122, a second sector, sector II 1124, and a third sector, sector III 1126. Line 1128 represents a sector boundary region between sector I 1122 and sector II 1124; line 1130 represents a sector boundary region between sector II 1124 and sector III 1126; line 1132 represents a boundary region between sector III 1126 and sector I 1122. Cell I 1102 includes a base station (BS), base station I 1106, and a plurality of end nodes (ENs) in each sector 1110, 1112, 1114. Sector I 1110 includes EN(1) 1136 and EN(X) 1138 coupled to BS 1106 via wireless links 1140, 1142, respectively; sector II 1112 includes EN(1′) 1144 and EN(X′) 1146 coupled to BS 1106 via wireless links 1148, 1150, respectively; sector III 1114 includes EN(1″) 1152 and EN(X″) 1154 coupled to BS 1106 via wireless links 1156, 1158, respectively. Similarly, cell M 1104 includes base station M 1108, and a plurality of end nodes (ENs) in each sector 1122, 1124, and 1126. Sector I 1122 includes EN(1) 1136′ and EN(X) 1138′ coupled to BS M 1108 via wireless links 1140′, 1142′, respectively; sector II 1124 includes EN(1′) 1144′ and EN(X′) 1146′ coupled to BS M 1108 via wireless links 1148′, 1150′, respectively; sector 3 1126 includes EN(1″) 1152′ and EN(X″) 1154′ coupled to BS 1108 via wireless links 1156′, 1158′, respectively.

System 1100 also includes a network node 1160 which is coupled to BS I 1106 and BS M 1108 via network links 1162, 1164, respectively. Network node 1160 is also coupled to other network nodes, e.g., other base stations, AAA server nodes, intermediate nodes, routers, etc. and the Internet via network link 1166. Network links 1162, 1164, 1166 may be, e.g., fiber optic cables. Each end node, e.g. EN 1 1136 may be a wireless terminal including a transmitter as well as a receiver. The wireless terminals, e.g., EN(1) 1136 may move through system 1100 and may communicate via wireless links with the base station in the cell in which the EN is currently located. The wireless terminals, (WTs), e.g. EN(1) 1136, may communicate with peer nodes, e.g., other WTs in system 1100 or outside system 1100 via a base station, e.g. BS 1106, and/or network node 1160. WTs, e.g., EN(1) 1136 may be mobile communications devices such as cell phones, personal data assistants with wireless modems, etc. Respective base stations perform tone subset allocation using a different method for the strip-symbol periods, from the method employed for allocating tones and determining tone hopping in the rest symbol periods, e.g., non strip-symbol periods. The wireless terminals use the tone subset allocation method along with information received from the base station, e.g., base station slope ID, sector ID information, to determine tones that they can employ to receive data and information at specific strip-symbol periods. The tone subset allocation sequence is constructed, in accordance with various aspects to spread inter-sector and inter-cell interference across respective tones. Although the subject system was described primarily within the context of cellular mode, it is to be appreciated that a plurality of modes may be available and employable in accordance with aspects described herein.

### Exemplary Base Station

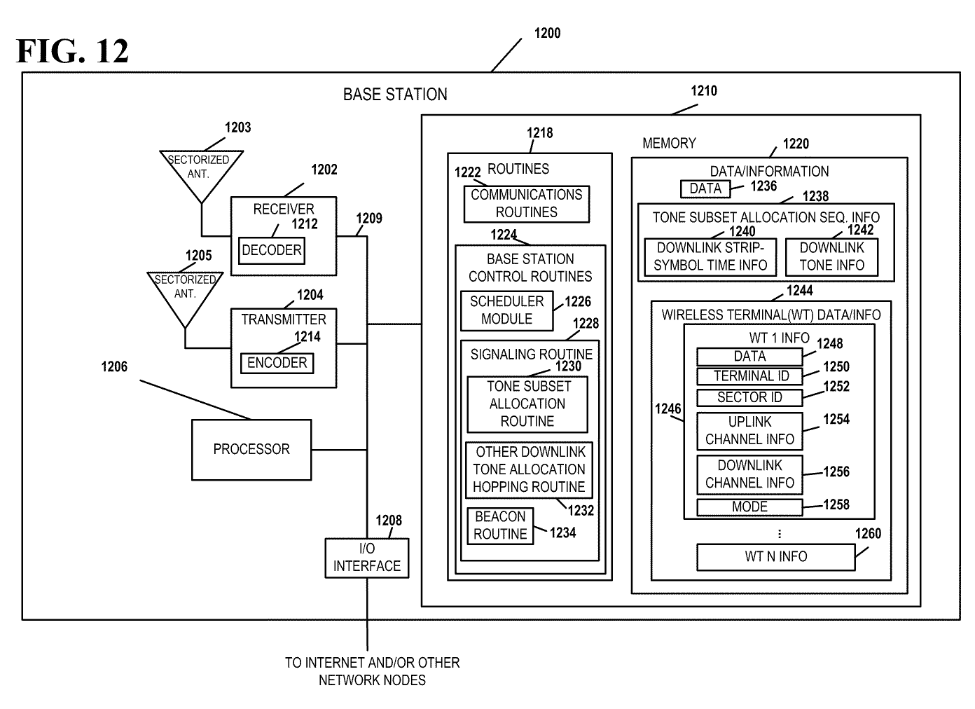

FIG. 12 illustrates an example base station 1200 in accordance with various aspects. Base station 1200 implements tone subset allocation sequences, with different tone subset allocation sequences generated for respective different sector types of the cell. Base station 1200 may be used as any one of base stations 1106, 1108 of the system 1100 of FIG. 11. The base station 1200 includes a receiver 1202, a transmitter 1204, a processor 1206, e.g., CPU, an input/output interface 1208 and memory 1210 coupled together by a bus 1209 over which various elements 1202, 1204, 1206, 1208, and 1210 may interchange data and information.

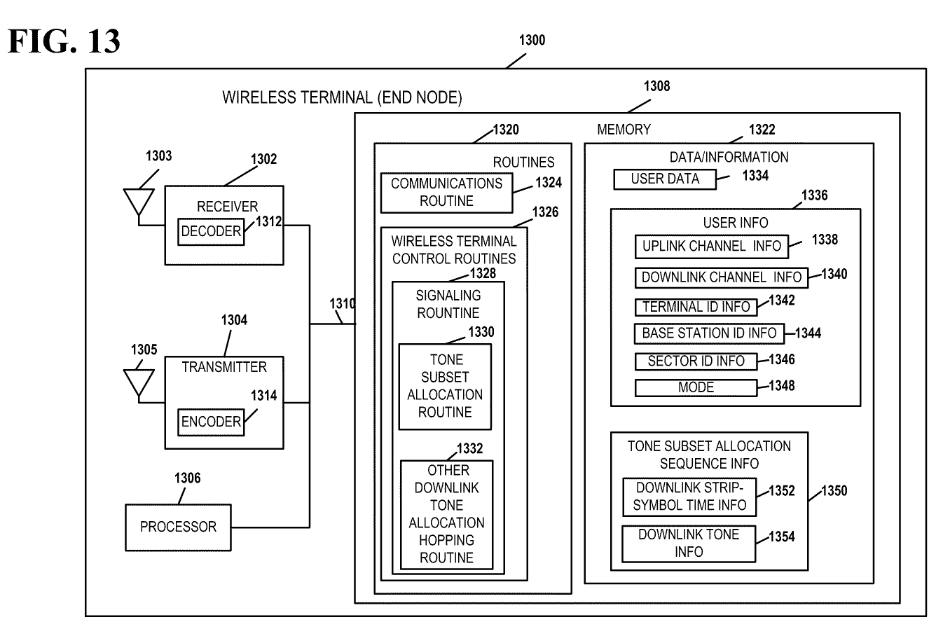

Sectorized antenna 1203 coupled to receiver 1202 is used for receiving data and other signals, e.g., channel reports, from wireless terminals transmissions from each sector within the base station's cell. Sectorized antenna 1205 coupled to transmitter 1204 is used for transmitting data and other signals, e.g., control signals, pilot signal, beacon signals, etc. to wireless terminals 1300 (see FIG. 13) within each sector of the base station's cell. In various aspects, base station 1200 may employ multiple receivers 1202 and multiple transmitters 1204, e.g., an individual receivers 1202 for each sector and an individual transmitter 1204 for each sector. Processor 1206, may be, e.g., a general purpose central processing unit (CPU). Processor 1206 controls operation of base station 1200 under direction of one or more routines 1218 stored in memory 1210 and implements the methods. I/O interface 1208 provides a connection to other network nodes, coupling the BS 1200 to other base stations, access routers, AAA server nodes, etc., other networks, and the Internet. Memory 1210 includes routines 1218 and data/information 1220.

Data/information 1220 includes data 1236, tone subset allocation sequence information 1238 including downlink strip-symbol time information 1240 and downlink tone information 1242, and wireless terminal (WT) data/info 1244 including a plurality of sets of WT information: WT 1 info 1246 and WT N info 1260. Each set of WT info, e.g., WT 1 info 1246 includes data 1248, terminal ID 1250, sector ID 1252, uplink channel information 1254, downlink channel information 1256, and mode information 1258.

Routines 1218 include communications routines 1222 and base station control routines 1224. Base station control routines 1224 includes a scheduler module 1226 and signaling routines 1228 including a tone subset allocation routine 1230 for strip-symbol periods, other downlink tone allocation hopping routine 1232 for the rest of symbol periods, e.g., non strip-symbol periods, and a beacon routine 1234.

Data 1236 includes data to be transmitted that will be sent to encoder 1214 of transmitter 1204 for encoding prior to transmission to WTs, and received data from WTs that has been processed through decoder 1212 of receiver 1202 following reception. Downlink strip-symbol time information 1240 includes the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone information 1242 includes information including a carrier frequency assigned to the base station 1200, the number and frequency of tones, and the set of tone subsets to be allocated to the strip-symbol periods, and other cell and sector specific values such as slope, slope index and sector type.

Data 1248 may include data that WT1 1300 has received from a peer node, data that WT 1 1300 desires to be transmitted to a peer node, and downlink channel quality report feedback information. Terminal ID 1250 is a base station 1200 assigned ID that identifies WT1 1300. Sector ID 1252 includes information identifying the sector in which WT1 1300 is operating. Sector ID 1252 can be used, for example, to determine the sector type. Uplink channel information 1254 includes information identifying channel segments that have been allocated by scheduler 1226 for WT1 1300 to use, e.g., uplink traffic channel segments for data, dedicated uplink control channels for requests, power control, timing control, etc. Each uplink channel assigned to WT1 1300 includes one or more logical tones, each logical tone following an uplink hopping sequence. Downlink channel information 1256 includes information identifying channel segments that have been allocated by scheduler 1226 to carry data and/or information to WT1 1300, e.g., downlink traffic channel segments for user data. Each downlink channel assigned to WT1 1300 includes one or more logical tones, each following a downlink hopping sequence. Mode information 1258 includes information identifying the state of operation of WT1 1300, e.g. sleep, hold, on.

Communications routines 1222 control the base station 1200 to perform various communications operations and implement various communications protocols. Base station control routines 1224 are used to control the base station 1200 to perform basic base station functional tasks, e.g., signal generation and reception, scheduling, and to implement the steps of the method of some aspects including transmitting signals to wireless terminals using the tone subset allocation sequences during the strip-symbol periods.

Signaling routine 1228 controls the operation of receiver 1202 with its decoder 1212 and transmitter 1204 with its encoder 1214. The signaling routine 1228 is responsible controlling the generation of transmitted data 1236 and control information. Tone subset allocation routine 1230 constructs the tone subset to be used in a strip-symbol period using the method of the aspect and using data/info 1220 including downlink strip-symbol time info 1240 and sector ID 1252. The downlink tone subset allocation sequences will be different for each sector type in a cell and different for adjacent cells. The WTs 1300 receive the signals in the strip-symbol periods in accordance with the downlink tone subset allocation sequences; the base station 1200 uses the same downlink tone subset allocation sequences in order to generate the transmitted signals. Other downlink tone allocation hopping routine 1232 constructs downlink tone hopping sequences, using information including downlink tone information 1242, and downlink channel information 1256, for the symbol periods other than the strip-symbol periods. The downlink data tone hopping sequences are synchronized across the sectors of a cell. Beacon routine 1234 controls the transmission of a beacon signal, e.g., a signal of relatively high power signal concentrated on one or a few tones, which may be used for synchronization purposes, e.g., to synchronize the frame timing structure of the downlink signal and therefore the tone subset allocation sequence with respect to an ultra-slot boundary.

### Exemplary Wireless Terminal

FIG. 13 illustrates an example wireless terminal (end node) 1300 which can be used as any one of the wireless terminals (end nodes), e.g., EN(1) 1136, of the system 1100 shown in FIG. 11. Wireless terminal 1300 implements the tone subset allocation sequences. The wireless terminal 1300 includes a receiver 1302 including a decoder 1312, a transmitter 1304 including an encoder 1314, a processor 1306, and memory 1308 which are coupled together by a bus 1310 over which the various elements 1302, 1304, 1306, 1308 can interchange data and information. An antenna 1303 used for receiving signals from a base station (and/or a disparate wireless terminal) is coupled to receiver 1302. An antenna 1305 used for transmitting signals, e.g., to a base station (and/or a disparate wireless terminal) is coupled to transmitter 1304.

The processor 1306, e.g., a CPU controls the operation of the wireless terminal 1300 and implements methods by executing routines 1320 and using data/information 1322 in memory 1308.

Data/information 1322 includes user data 1334, user information 1336, and tone subset allocation sequence information 1350. User data 1334 may include data, intended for a peer node, which will be routed to encoder 1314 for encoding prior to transmission by transmitter 1304 to a base station, and data received from the base station which has been processed by the decoder 1312 in receiver 1302. User information 1336 includes uplink channel information 1338, downlink channel information 1340, terminal ID information 1342, base station ID information 1344, sector ID information 1346, and mode information 1348. Uplink channel information 1338 includes information identifying uplink channels segments that have been assigned by a base station for wireless terminal 1300 to use when transmitting to the base station. Uplink channels may include uplink traffic channels, dedicated uplink control channels, e.g., request channels, power control channels and timing control channels. Each uplink channel includes one or more logic tones, each logical tone following an uplink tone hopping sequence. The uplink hopping sequences are different between each sector type of a cell and between adjacent cells. Downlink channel information 1340 includes information identifying downlink channel segments that have been assigned by a base station to WT 1300 for use when the base station is transmitting data/information to WT 1300. Downlink channels may include downlink traffic channels and assignment channels, each downlink channel including one or more logical tone, each logical tone following a downlink hopping sequence, which is synchronized between each sector of the cell.

User info 1336 also includes terminal ID information 1342, which is a base station-assigned identification, base station ID information 1344 which identifies the specific base station that WT has established communications with, and sector ID info 1346 which identifies the specific sector of the cell where WT 1300 is presently located. Base station ID 1344 provides a cell slope value and sector ID info 1346 provides a sector index type; the cell slope value and sector index type may be used to derive tone hopping sequences. Mode information 1348 also included in user info 1336 identifies whether the WT 1300 is in sleep mode, hold mode, or on mode.

Tone subset allocation sequence information 1350 includes downlink strip-symbol time information 1352 and downlink tone information 1354. Downlink strip-symbol time information 1352 include the frame synchronization structure information, such as the superslot, beaconslot, and ultraslot structure information and information specifying whether a given symbol period is a strip-symbol period, and if so, the index of the strip-symbol period and whether the strip-symbol is a resetting point to truncate the tone subset allocation sequence used by the base station. Downlink tone info 1354 includes information including a carrier frequency assigned to the base station, the number and frequency of tones, and the set of tone subsets to be allocated to the strip-symbol periods, and other cell and sector specific values such as slope, slope index and sector type.

Routines 1320 include communications routines 1324 and wireless terminal control routines 1326. Communications routines 1324 control the various communications protocols used by WT 1300. Wireless terminal control routines 1326 controls basic wireless terminal 1300 functionality including the control of the receiver 1302 and transmitter 1304. Wireless terminal control routines 1326 include the signaling routine 1328. The signaling routine 1328 includes a tone subset allocation routine 1330 for the strip-symbol periods and an other downlink tone allocation hopping routine 1332 for the rest of symbol periods, e.g., non strip-symbol periods. Tone subset allocation routine 1330 uses user data/info 1322 including downlink channel information 1340, base station ID info 1344, e.g., slope index and sector type, and downlink tone information 1354 in order to generate the downlink tone subset allocation sequences in accordance with some aspects and process received data transmitted from the base station. Other downlink tone allocation hopping routine 1330 constructs downlink tone hopping sequences, using information including downlink tone information 1354, and downlink channel information 1340, for the symbol periods other than the strip-symbol periods. Tone subset allocation routine 1330, when executed by processor 1306, is used to determine when and on which tones the wireless terminal 1300 is to receive one or more strip-symbol signals from the base station 1200. The uplink tone allocation hopping routine 1330 uses a tone subset allocation function, along with information received from the base station, to determine the tones in which it should transmit on.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

When the embodiments are implemented in program code or code segments, it should be appreciated that a code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc. Additionally, in some aspects, the steps and/or actions of a method or algorithm can reside as one or any combination or set of codes and/or instructions on a machine readable medium and/or computer readable medium, which can be incorporated into a computer program product.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

Furthermore, as used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

What is claimed is:

1. A method that facilitates reestablishing a communication with a network, the method comprising:
transmitting a reestablishment request via a source carrier;
receiving a reestablishment command, wherein the reestablishment command includes configuration data associated with at least one target carrier; and
establishing a radio resource connection via the at least one target carrier by employing a signaling format that facilitates a potential configuration associated with a plurality of target carriers.

2. The method of claim 1, wherein the at least one target carrier is operated on a same frequency as the source carrier.

3. The method of claim 1, wherein the at least one target carrier is operated on a different frequency from the source carrier.

4. The method of claim 1, wherein the at least one target carrier includes a plurality of carriers.

5. The method of claim 1, further comprising detecting a radio link failure, wherein the transmitting of the reestablishment request is triggered by the radio link failure.

6. The method of claim 1, further comprising detecting a failure in a transport layer of a wireless system, wherein the transmitting of the reestablishment request is triggered by the failure in the transport layer.

7. The method of claim 1, further comprising detecting a handover command, wherein the transmitting of the reestablishment request is triggered by the handover command.

8. The method of claim 1, wherein at least one radio resource connection includes a signaling radio bearer.

9. The method of claim 1, wherein the reestablishment command is received by a wireless terminal from a network node, and wherein the network node previously provided a service to the wireless terminal.

10. The method of claim 9, wherein the network node is a node that previously allocated radio resources to the wireless terminal on the at least one target carrier.

11. An apparatus configured to facilitate reestablishing a communication with a network, the apparatus comprising:
a processor configured to execute computer executable components stored in memory, the components including:
a transmitting component configured to transmit a reestablishment request via a source carrier;
a receiving component configured to receive a reestablishment command, wherein the reestablishment command includes configuration data associated with at least one target carrier; and
a connecting component configured to establish a radio resource connection via the at least one target carrier by employing a signaling format that facilitates a potential configuration associated with a plurality of target carriers.

12. The apparatus of claim 11, wherein the at least one target carrier is operated on a same frequency as the source carrier.

13. The apparatus of claim 11, wherein the at least one target carrier is operated on a different frequency from the source carrier.

14. The apparatus of claim 11, wherein the at least one target carrier includes a plurality of carriers.

15. The apparatus of claim 11, further comprising a triggering component configured to detect a radio link failure, wherein a transmission of the reestablishment request is triggered by the radio link failure.

16. The apparatus of claim 11, further comprising a triggering component configured to detect a failure in a transport layer of a wireless system, wherein a transmission of the reestablishment request is triggered by the failure in the transport layer.

17. The apparatus of claim 11, further comprising a triggering component configured to detect a handover command, wherein a transmission of the reestablishment request is triggered by the handover command.

18. The apparatus of claim 11, wherein at least one radio resource connection includes a signaling radio bearer.

19. The apparatus of claim 11, wherein the reestablishment command is received by a wireless terminal from a network node, and wherein the network node previously provided a service to the wireless terminal.

20. The apparatus of claim 19, wherein the network node is a node that previously allocated radio resources to the wireless terminal on the at least one target carrier.

21. A computer program product that facilitates reestablishing a communication with a network, comprising:
a computer-readable storage medium comprising code for causing at least one computer to:
transmit a reestablishment request via a source carrier;
receive a reestablishment command, wherein the reestablishment command includes configuration data associated with at least one target carrier; and
establish a radio resource connection via the at least one target carrier by employing a signaling format that facilitates a potential configuration associated with a plurality of target carriers.

22. The computer program product of claim 21, wherein the code further causes the at least one computer to detect a radio link failure, and wherein a transmission of the reestablishment request is triggered by the radio link failure.

23. The computer program product of claim 21, wherein the code further causes the at least one computer to detect a failure in a transport layer of a wireless system, and wherein a transmission of the reestablishment request is triggered by the failure in the transport layer.

24. The computer program product of claim 21, wherein the code further causes the at least one computer to detect a handover command, and wherein a transmission of the reestablishment request is triggered by the handover command.

25. The computer program product of claim 21, wherein at least one radio resource connection includes a signaling radio bearer.

26. An apparatus configured to facilitate reestablishing a communication with a network, the apparatus comprising:
means for transmitting a reestablishment request via a source carrier;
means for receiving a reestablishment command, wherein the reestablishment command includes configuration data associated with at least one target carrier; and
means for establishing a radio resource connection via the at least one target carrier by employing a signaling format that facilitates a potential configuration associated with a plurality of target carriers.

27. The apparatus of claim 26, wherein the at least one target carrier is operated on a same frequency as the source carrier.

28. The apparatus of claim 26, wherein the at least one target carrier is operated on a different frequency from the source carrier.

29. The apparatus of claim 26, wherein the at least one target carrier includes a plurality of carriers.

30. The apparatus of claim 26, wherein the reestablishment command is received by a wireless terminal from a network node, and wherein the network node previously provided a service to the wireless terminal.

31. The apparatus of claim 30, wherein the network node is a node that previously allocated radio resources to the wireless terminal on the at least one target carrier.

32. A method that facilitates reestablishing a communication with a wireless terminal, the method comprising:
receiving a reestablishment request via a source carrier;
selecting a target carrier subset from a set of candidate carriers;
generating a reestablishment command, wherein the reestablishment command includes configuration data associated with the target carrier subset; and
transmitting the reestablishment command, wherein the reestablishment command is configured to facilitate establishing a radio resource connection via the target carrier subset by employing a signaling format that facilitates a potential configuration associated with a plurality of target carriers.

33. The method of claim 32, wherein the target carrier subset includes a single carrier, and wherein the single carrier operates on a same frequency as the source carrier.

34. The method of claim 32, wherein the target carrier subset includes a single carrier, and wherein the single carrier operates on a different frequency from the source carrier.

35. The method of claim 32, wherein the target carrier subset includes a plurality of carriers.

36. The method of claim 32, further comprising monitoring a usage of the set of candidate carriers, wherein the selecting is based on the usage.

37. The method of claim 32, wherein the reestablishment command is transmitted to the wireless terminal from a network node, and wherein the network node previously provided a service to the wireless terminal.

38. The method of claim 32, wherein the reestablishment command is transmitted to the wireless terminal from a network node, and wherein the network node is a node that previously allocated radio resources to the wireless terminal on at least one carrier included in the target carrier subset.

39. An apparatus configured to facilitate reestablishing a communication with a wireless terminal, the apparatus comprising:
a processor configured to execute computer executable components stored in memory, the components including:
a receiving component configured to receive a reestablishment request via a source carrier;
a selection component configured to select a target carrier subset from a set of candidate carriers;
a generation component configured to generate a reestablishment command, wherein the reestablishment command includes configuration data associated with the target carrier subset; and
a transmitting component configured to transmit the reestablishment command, wherein the reestablishment command is configured to facilitate establishing a radio resource connection via the target carrier subset by employing a signaling format that facilitates a potential configuration associated with a plurality of target carriers.

40. The apparatus of claim 39, wherein the target carrier subset includes a single carrier, and wherein the single carrier is operated on a same frequency as the source carrier.

41. The apparatus of claim 39, wherein the target carrier subset includes a single carrier, and wherein the single carrier is operated on a different frequency from the source carrier.

42. The apparatus of claim 39, wherein the target carrier subset includes a plurality of carriers.

43. The apparatus of claim 39, wherein the selection component is further configured to monitor a usage of the set of candidate carriers, and wherein the target carrier subset is selected based on the usage.

44. The apparatus of claim 39, wherein the transmitting component is configured to transmit the reestablishment command to the wireless terminal from a network node, and wherein the network node is a node that previously provided a service to the wireless terminal.

45. The apparatus of claim 39, wherein the transmitting component is configured to transmit the reestablishment command to the wireless terminal from a network node, and wherein the network node is a node that previously allocated radio resources to the wireless terminal on at least one carrier included in the target carrier subset.

46. A computer program product that facilitates reestablishing a communication with a wireless terminal, comprising:
a computer-readable storage medium comprising code for causing at least one computer to:
receive a reestablishment request via a source carrier;
select a target carrier subset from a set of candidate carriers;
generate a reestablishment command, wherein the reestablishment command includes configuration data associated with the target carrier subset; and
transmit the reestablishment command, wherein the reestablishment command is configured to facilitate establishing a radio resource connection via the target carrier subset by employing a signaling format that facilitates a potential configuration associated with a plurality of target carriers.

47. The computer program product of claim 46, wherein the code further causes the at least one computer to monitor a usage of the set of candidate carriers, and wherein the target carrier subset is selected based on the usage.

48. The computer program product of claim 46, wherein the code further causes the at least one computer to transmit the reestablishment command to the wireless terminal from a network node, and wherein the network node is a node that previously provided a service to the wireless terminal

49. The computer program product of claim 46, wherein the code further causes the at least one computer to transmit the reestablishment command to the wireless terminal from a network node, and wherein the network node is a node that previously allocated radio resources to the wireless terminal on at least one carrier included in the target carrier subset.

50. An apparatus configured to facilitate reestablishing a communication with a wireless terminal, the apparatus comprising:
means for receiving a reestablishment request via a source carrier;
means for selecting a target carrier subset from a set of candidate carriers;
means for generating a reestablishment command, wherein the reestablishment command includes configuration data associated with the target carrier subset; and
means for transmitting the reestablishment command, wherein the reestablishment command is configured to facilitate establishing a radio resource connection via the target carrier subset by employing a signaling format that facilitates a potential configuration associated with a plurality of target carriers.

51. The apparatus of claim 50, wherein the target carrier subset includes a single carrier, and wherein the single carrier is operated on a same frequency as the source carrier.

52. The apparatus of claim 50, wherein the target carrier subset includes a single carrier, and wherein the single carrier is operated on a different frequency from the source carrier.

53. The apparatus of claim 50, wherein the target carrier subset includes a plurality of carriers.
